(19) United States
(12) Patent Application Publication
(10) Pub. No.: US 2010/0057732 A1
(43) Pub. Date: Mar. 4, 2010

(54) SYSTEM AND METHOD FOR IDENTIFYING SOCIAL NETWORK INTERSECTION IN INSTANT MESSAGING

(76) Inventors: Patrick Joseph O'Sullivan, Ballsbridge (IE); Carol Zimmet, Boxborough, MA (US); Sean Callanan, Churchtown (IE); Gary Denner, Celbridge (IE)

Correspondence Address: HOLLAND & KNIGHT, 10 ST. JAMES AVENUE, BOSTON, MA, 02116-3889, US

(21) Appl. No.: 12/202,626

(22) Filed: Sep. 2, 2008

(51) Int. Cl. G06F 17/30; G06F 15/16

(52) U.S. Cl. 707/6; 709/206; 707/E17.109

(57) ABSTRACT

A method and computer program product for identifying one or more instant messaging contacts associated with a first instant messaging contacts list, and identifying one or more instant messaging contacts associated with a second instant messaging contacts list. The one or more instant messaging contacts associated with the first instant messaging contacts list are compared to the one or more instant messaging contacts associated with the second instant messaging contacts list. One or more comparison instant messaging contacts are determined.

### FIELD OF THE DISCLOSURE

The present disclosure generally relates to instant messaging systems and methods, and more particularly relates to identifying social network intersections in instant messaging.

### BACKGROUND

Instant messaging provides a convenient tool of collaboration amongst individuals. For example, instant messaging may provide a communication medium that is akin to an actual real-time conversation. Over time, various users will accumulate a contacts list of other instant messaging users with whom they communicate. The contacts list, in and of itself, may represent a valuable piece of knowledge. However, the development of a contacts list typically occurs through an organic mechanism: slowly, over time, a user's contact list will grow as their instant messaging communications expand to include additional instant messaging users. This relatively slow growth may present the problem of a significant time lag while a new member of a team or organization slowly builds his instant messaging contacts list. While the new member's contact list is in early stages of growth, the new member may be inhibited from the potential benefits of instant messaging communication.

### SUMMARY OF THE DISCLOSURE

According to a first implementation a method includes identifying one or more instant messaging contacts associated with a first instant messaging contacts list, and identifying one or more instant messaging contacts associated with a second instant messaging contacts list. The one or more instant messaging contacts associated with the first instant messaging contacts list are compared to the one or more instant messaging contacts associated with the second instant messaging contacts list. One or more comparison instant messaging contacts are determined.

One or more of the following features may be included. Identifying one or more instant messaging contacts associated with the first instant messaging contacts list may include requesting one or more instant messaging contacts associated with the first instant messaging contacts list. Identifying one or more instant messaging contacts associated with the first instant messaging user may include receiving one or more instant messaging contacts associated with the first instant messaging contacts list based upon, at least in part, permissions defined relative to at least a portion of the one or more instant messaging contacts associated with the first instant messaging contacts list.

Identifying one or more instant messaging contacts associated with the first instant messaging contacts list may include querying a first instant messaging client. Identifying one or more instant messaging contacts associated with the first instant messaging contacts list may include querying a first instant messaging server associated with the first instant messaging contacts list.

The one or more comparison instant messaging contacts may be based upon, at least in part, one or more instant messaging contacts associated with both of the first instant messaging contacts list and the second instant messaging contacts list. One or more comparison instant messaging contacts may be associated with a third instant messaging contacts list. The one or more comparison instant messaging contacts may be based upon, at least in part, one or more instant messaging contacts exclusive to one of the first instant messaging contacts list or the second instant messaging contacts list. The one or more instant messaging contacts included within the one or more comparison instant messaging contacts may be associated with one of the first instant messaging contacts list and the second instant messaging contacts list.

Collaborative content associated with one or more of the comparison instant messaging contacts may be identified.

According to another implementation, a computer program product includes a computer readable medium having a plurality of instructions stored on it. When executed by a processor, the instructions cause the processor to perform operations including identifying one or more instant messaging contacts associated with a first instant messaging contacts list, and identifying one or more instant messaging contacts associated with a second instant messaging contacts list. The one or more instant messaging contacts associated with the first instant messaging contacts list are compared to the one or more instant messaging contacts associated with the second instant messaging contacts list. One or more comparison instant messaging contacts are determined.

One or more of the following features may be included. The instructions for identifying one or more instant messaging contacts associated with the first instant messaging contacts list may include instructions for requesting one or more instant messaging contacts associated with the first instant messaging contacts list. The instructions for identifying one or more instant messaging contacts associated with the first instant messaging contacts list may include instructions for receiving one or more instant messaging contacts associated with the first instant messaging contacts list based upon, at least in part, permissions defined relative to at least a portion of the one or more instant messaging contacts associated with the first instant messaging contacts list.

The instructions for identifying one or more instant messaging contacts associated with the first instant messaging contacts list may include instructions for querying a first instant messaging client. The instructions for identifying one or more instant messaging contacts associated with the first instant messaging contacts list may include instructions for querying a first instant messaging server associated with the first instant messaging contacts list.

The one or more comparison instant messaging contacts may be based upon, at least in part, one or more instant messaging contacts associated with both of the first instant messaging contacts list and the second instant messaging contacts list. Instructions may be included for associating one or more comparison instant messaging contacts with a third instant messaging contacts list. The one or more comparison instant messaging contacts may be based upon, at least in part, one or more instant messaging contacts exclusive to one of the first instant messaging contacts list or the second instant messaging contacts list. Instructions may be included for associating the one or more instant messaging contacts included within the one or more comparison instant messaging contacts with one of the first instant messaging contacts list and the second instant messaging contacts list.

Instructions may be included for identifying collaborative content associated with one or more of the one or more comparison instant messaging contacts.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a contacts intersection process coupled to a distributed computing network.

FIG. 2 is flowchart of a process performed by the contacts intersection process of FIG. 1.

FIG. 3 diagrammatically depicts a user interface generated by the contacts intersection process and/or an instant messaging application of FIG. 1.

FIG. 4 diagrammatically depicts a user interface generated by the contacts intersection process and/or the instant messaging application of FIG. 1.

FIG. 5 diagrammatically depicts a comparison of a contacts list associated with a first instant messaging user to a contacts list associated with a second instant messaging user.

FIG. 6 diagrammatically depicts a user interface generated by the contacts intersection process and/or the instant messaging application of FIG. 1.

FIG. 7 diagrammatically depicts a user interface generated by the contacts intersection process and/or the instant messaging application of FIG. 1.

FIG. 8 diagrammatically depicts a user interface generated by the contacts intersection process and/or the instant messaging application of FIG. 1.

### DETAILED DESCRIPTION

### System Overview:

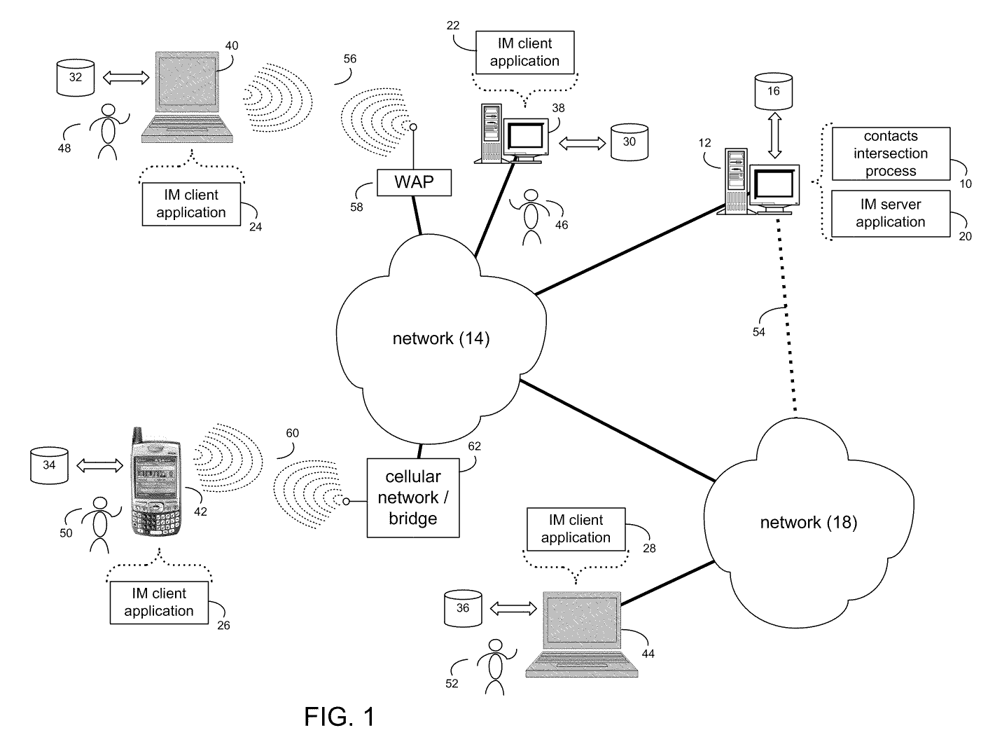

Referring to FIG. 1, there is shown contacts intersection process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally/alternatively, the contacts intersection process may reside on and be executed, in whole or in part, by one or more client electronic device, such as a personal computer, notebook computer, personal digital assistant, or the like.

As will be discussed below in greater detail, contacts intersection process 10 may identify one or more instant messaging contacts associated with a first instant messaging contacts list, and may identify one or more instant messaging contacts associated with a second instant messaging contacts list. The one or more instant messaging contacts associated with the first instant messaging contacts list may be compared to the one or more instant messaging contacts associated with the second instant messaging contacts list. One or more comparison instant messaging contacts may be determined.

The instruction sets and subroutines of contacts intersection process 10, which may include one or more software modules, and which may be stored on storage device 16 coupled to server computer 12, may be executed by one or more processors (not shown) and one or more memory architectures (not shown) incorporated into server computer 12. Storage device 16 may include but is not limited to: a hard disk drive; a solid state drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute instant messaging server application 20, examples of which may include, but are not limited to IBM Lotus Sametime™, Microsoft Office Live Communications Server™, Jabber XCP™, and AOL Instant Messenger™. Instant messaging server application 20 may route instant messages to instant messaging client applications, e.g., instant messaging client applications 22, 24, 26, 28, examples of which may include but are not limited to IBM Lotus Sametime™, Microsoft Office Communicator™, Google Talk™, and AOL Instant Messenger™, for example. Contacts intersection process 10 may be a stand alone application that interfaces with instant messaging server application 20 or an applet/application that is executed within instant messaging server application 20.

The instruction sets and subroutines of instant messaging server application 20, which may be stored on storage device 16 coupled to server computer 12, may be executed by one or more processors (not shown) and one or more memory architectures (not shown) incorporated into server computer 12.

The instruction sets and subroutines of instant messaging client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; solid state drives; tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using instant messaging client applications 22, 24, 26, 28, users 46, 48, 50, 52 may access instant messaging server application 20 and may receive, create, and manage instant messages.

As mentioned above, in addition/as an alternative to being a server-side application residing on server computer 12, the contacts intersection process may be a client-side application (not shown) residing on one or more client electronic device (e.g., personal computer 38; or client electronic devices 40, 42, 44; not shown). In a client-side implementation, the contacts intersection process may be a stand alone application that interfaces with an instant messaging client application (e.g., instant messaging client applications 22, 24, 26, 28), or may be an applet/application that is executed within an instant messaging client application. As such, the contacts intersection process may be a client-side process, a server-side process, or a hybrid client-side/server-side process (e.g., the combination of server-side contacts intersection process 10 and one or more client-side contacts intersection processes), which may be executed, in whole or in part, by server computer 12, and/or one or more of client electronic device (e.g., client electronic devices 38, 40, 42, 44).

Users 46, 48, 50, 52 may access instant messaging server application 20 directly through client electronic devices 38, 40, 42, 44 upon which instant messaging client applications 22, 24, 26, 28 are executed. Users 46, 48, 50, 52 may access instant messaging server application 20 directly through network 14 or through secondary network 18. Further, server computer 12 (i.e., the computer that executes instant messaging server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Contacts Intersection Process

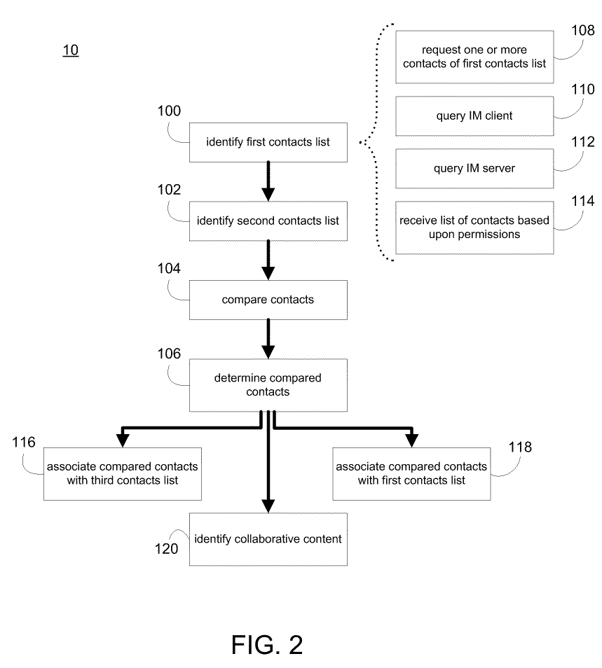

Referring also to FIG. 2, contacts intersection process 10 may identify 100 one or more instant messaging contacts associated with a first instant messaging contacts list, and may identify 102 one or more instant messaging contacts associated with a second instant messaging contacts list. Contacts intersection process 10 may further compare 104 the one or more instant messaging contacts associated with the first instant messaging contacts list to the one or more instant messaging contacts associated with the second instant messaging contacts list. One or more comparison instant messaging contacts may be determined 106.

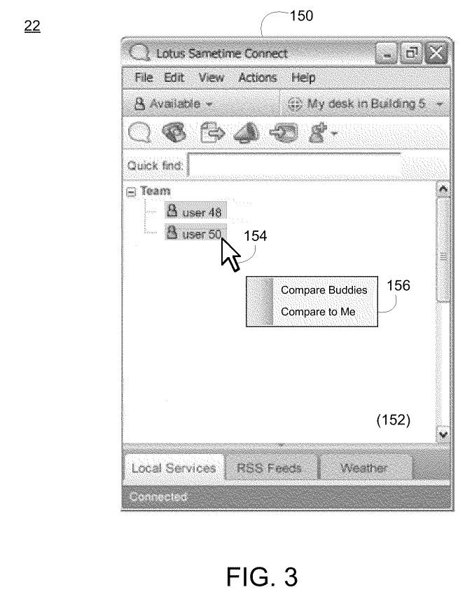

For example, and referring also to FIG. 3, an instant messaging client application (e.g., instant messaging client application 22) may render instant messaging contacts display 150, which may allow a user (e.g., user 46) to view the user's instant messaging contacts (e.g., via contacts list 152), namely “user 48” and “user 50”, in the illustrated example. Contacts intersection process 10 may allow user 46 to extract knowledge from user 46's instant messaging contacts (i.e., user 48, user 50), e.g., based upon, at least in part, the common or differing instant messaging contacts of one or more of user 46's instant messaging contacts (i.e., common or differing instant messaging contacts of user 48 and user 50) as well as common or differing contacts of user 46 and one or more of user 46's instant messaging contacts.

For example, user 46 may select, via onscreen pointer 154 (e.g., which may be controlled by a pointing device, such as a mouse; not shown) one or more instant messaging contacts (e.g., user 48 and user 50) from instant messaging contacts list 152. User 46 may, e.g., right-click, on one or more of the selected instant messaging contacts (i.e., user 48 and user 50) resulting in contacts intersection process 10 (alone or in conjunction with one or more of instant messaging server application 20 and/or instant messaging client application 22) render pop-up menu 156. While pop-up menu 156 is shown only including two options, i.e., “Compare Buddies” and “Compare to Me”, this is intended for the purpose of illustration only, and not as a limitation of this disclosure as pop-up menu 156 may include any number or variety of options, the number and nature of which may vary according to user need and design criteria.

User 46 may select, e.g., using onscreen pointer 154, “Compare Buddies” option from within pop-up menu 156, causing contacts intersection process 10 identify 100 one or more instant messaging contacts associated with a first instant messaging contacts list (e.g., an instant messaging contacts list associated with a first instant messaging user, e.g., user 48) and to identify 102 one or more instant messaging contacts associated with a second instant messaging contacts list (e.g., an instant messaging contacts list associated with a second instant messaging user, e.g., user 50).

Identifying 100 one or more instant messaging contacts associated with the first instant messaging contacts list (i.e., a contacts list associated with user 48) may include requesting 108 one or more instant messaging contacts associated with the first instant messaging contacts list. Continuing with the above-stated example, in which the first instant messaging contacts list includes an instant messaging contacts list associated with user 48, contacts intersection process 10 may request 108 one or more instant messaging contacts associated with user 48's instant messaging contacts list (e.g., one or more contacts included within user 48's contacts list or buddy list).

Instant messaging contacts associated with an instant messaging contacts list may be accessible via one or more of an instant messaging client associated with the instant messaging contacts list (e.g., associated with an instant messaging user) and an instant messaging server associated with the instant messaging contacts list, e.g., depending upon the instant messaging system(s) and network topology. Accordingly, and continuing with the above stated example, identifying 100 one or more instant messaging contacts associated with the first instant messaging contacts list (e.g., of instant messaging user 48) may include querying a first instant messaging client. For example, contacts intersection process 10 may query instant messaging client application 24 for instant messaging contacts associated with user 48 (e.g., the first instant messaging contacts list). Similarly, identifying 100 one or more instant messaging contacts associated with the first instant messaging contacts list may include querying 112 a first instant messaging server associated with the first instant messaging contacts list. For example, contacts intersection process 10 may query instant messaging server application 20, for instant messaging contacts associated with user 48 (e.g., for instant messaging contacts associated with the first instant messaging contacts list).

While not shown, contacts intersection process 10 may identify 102 instant messaging contacts associated with a second instant messaging contacts list (e.g., an instant messaging contacts list associated with user 50), e.g., in a generally similar manner as described with respect to identifying 100 instant messaging contacts associated with the first instant messaging contacts list, which may be associated with user 48. For example, identifying 102 instant messaging contacts associated with user 50 (i.e., the second instant messaging contacts list) may include requesting a list of instant messaging contacts associated with user 50. Contacts intersection process 10 may query one or more of an instant messaging client associated with user 50 (e.g., instant messaging client application 26) and an instant messaging server associated with user 50 (e.g., instant messaging server application 20).

Identifying 100 one or more instant messaging contacts associated with the first instant messaging contacts list may include receiving 114 one or more instant messaging contacts associated with the first instant messaging contacts list based upon, at least in part, permissions defined relative to at least a portion of the one or more instant messaging contacts associated with the first instant messaging contacts list. Continuing with the above-stated example, in which the first instant messaging contacts list is an instant messaging contacts list associated with user 48, user 48 may choose to only make a portion of instant messaging contacts accessible. For example, user 48's instant messaging contacts may include contacts that are personal contacts as well as instant messaging contacts that are business related contacts. User 48 may only wish to allow business related contacts to be accessible to others. As such, user 48 may set permissions relative to various instant messaging contacts.

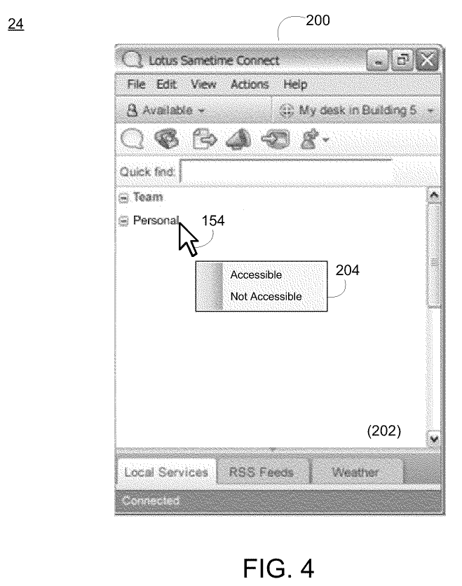

Continuing with the above-stated example, and referring also to FIG. 4, instant messaging client application 24 may provide instant messaging contacts interface 200, including listing 202 of user 48's instant messaging contacts (i.e., the first instant messaging contacts list). As shown in the illustrated example, listing 202 may include various groups of instant messaging contacts (namely “Team” and “Personal” in the illustrated example), which may be defined by, and associated with, user 48. Instant messaging client application 24, alone and/or in conjunction with one or more of contacts intersection process 10 and/or instant messaging server application 20, may allow user 48 to define permissions relative to one or more groups of contacts, and/or to individual contacts (not shown). For example, user 48 may select, via onscreen pointer 154, a group of contacts (e.g., “Personal”) and/or an individual contact (not shown) within listing 202. Selecting contacts group “Personal” (e.g., and by right-clicking on the group) may result in contacts intersection process (alone and/or in conjunction with one or more of instant messaging client application 24 and/or instant messaging server application 20) rendering pop-up menu 204. While pop-up menu 204 is shown including only two options (namely “Accessible” and “Not Accessible”), this is intended for the purpose of illustration only and not as a limitation on this disclosure. The number and nature of options included within pop-up menu 204 may vary according to user need and design criteria. Continuing with this example, user 48 may selection “Not Accessible” option from pop-up menu 204, which may result in instant messaging client application 24, instant messaging server application 20, and/or contacts intersection process 10 making user 48's Personal instant messaging contacts inaccessible, e.g., for the purpose of comparing instant messaging contacts.

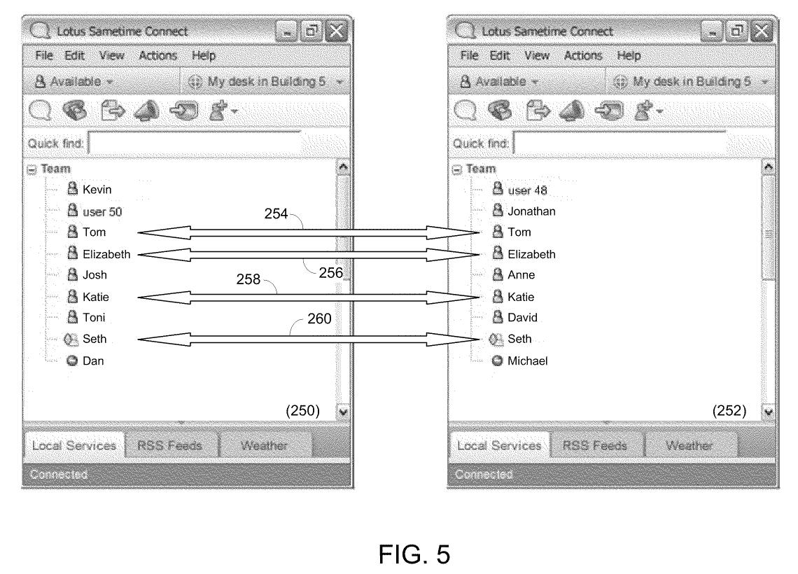

As mentioned above, identifying 100 one or more instant messaging contacts associated with the first instant messaging contacts list may include receiving 114 one or more instant messaging contacts associated with the first instant messaging contacts list based upon, at least in part, permissions defined relative to at least a portion of the one or more instant messaging contacts associated with the first instant messaging contacts list. Continuing with the above-stated example, and referring also to FIG. 5, contacts intersection process 10 may receive 114 list 250 including one or more instant messaging contacts associated with the first instant messaging contacts list based upon, at least in part, permissions defined (e.g., by user 48) relative to at least a portion of the one or more instant messaging contacts associated with user 48. For example, as shown, and further to the above-discussed example, list 250 of instant messaging contacts associated with user 48 may only include “Team” contacts, and may not include “Personal” contacts. Contacts intersection process 10 may similarly receive list 252 including one or more instant messaging contacts associated with the second instant messaging contacts list (i.e., instant messaging contacts associated with user 50)

With continued reference to FIG. 5, contacts intersection process 10 may compare 104 the contacts associated with the first instant messaging contacts list (i.e., contacts from list 250 associated with user 48) to the contacts associated with the second instant messaging contacts list (i.e., contacts from list 252 associated with user 50). As shown, comparing 104 the contacts associated with the first instant messaging contacts list to the contacts associated with the second instant messaging contacts list may allow contacts intersection process 10 to identify one or more contacts common to both list 250 and list 252 (e.g., as correlated by arrows 254, 256, 25 8, 260).

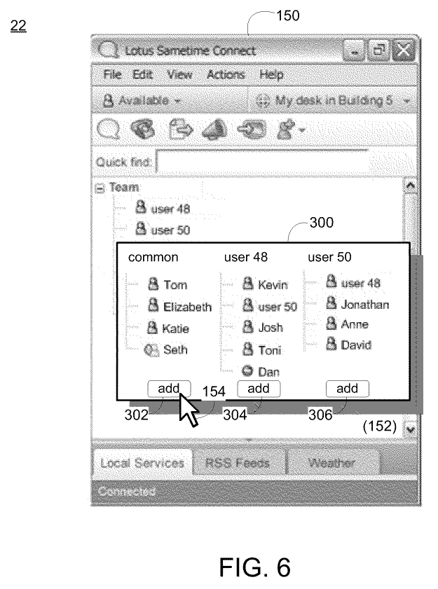

Contacts intersection process 10 may determine 106 one or more comparison instant messaging contacts. Continuing with the above-stated example, and referring also to FIG. 6, contacts intersection process 10 (alone or in conjunction with one or more of instant messaging client application 22 and instant messaging server application 20) may render comparison pop-up 300, e.g., relative to instant messaging contacts display 150. The one or more comparison instant messaging contacts may be based upon, at least in part, one or more instant messaging contacts associated with both of the first instant messaging contacts list and the second instant messaging contacts list. For example, as shown in comparison pop-up 300, contacts intersection process 10 may indicate one or more instant messaging contacts common to both list 250 and 252 (e.g., Tom, Elizabeth, Katie, and Seth under the column heading “common”).

Contacts intersection process 10 may associate 116 one or more comparison instant messaging contacts with a third instant messaging contacts list. For example, user 46 may select, via onscreen pointer 154, “add” button 302 in comparison pop-up 300, resulting in contacts intersection process 10 (alone or in conjunction with one or more of instant messaging client application 22 and/or instant messaging server application 20) associating 116 the common contacts (i.e., Tom, Elizabeth, Katie, and Seth) with an instant messaging contacts list associated with user 46 (who may be a third instant messaging user relative to user 48 and user 50), e.g., by adding the common contacts to user 46's instant messaging contacts list (e.g., contacts list 152). As such, user 46, who may be a new member of the team may easily gain access to instant messaging contacts that may be useful in the context of user 46's membership on the team, e.g., as evidence by the common presence of the instant messaging contacts on both user 48 and user 50's instant messaging contacts list.

Further, the one or more comparison instant messaging contacts may be based upon, at least in part, one or more instant messaging contacts exclusive to one of the first instant messaging contacts list or the second instant messaging contacts list. For example, as shown, contacts intersection process 10 may identify instant messaging contacts that are exclusive to user 48 (e.g., instant messaging contacts associated with user 48 but not associated with user 50, i.e., Kevin, user 50, Josh, Toni, and Dan under the column heading “user 48” in comparison pop-up 300). Similarly, contacts intersection process 10 may identify instant messaging contacts that are exclusive to user 50 (e.g., instant messaging contact associated with user 50 but not associated with user 48, i.e., user 48, Jonathan, Anne, David, and Michael under the column heading “user 50” in comparison pop-up 300).

In a similar manner to the addition of common contacts, user 46 may select “add” button 304 and/or “add” button 306 resulting in contacts intersection process 10 (alone or in conjunction with one or more of instant messaging client application 22 and/or instant messaging server application 20) associating 116 the instant messaging contacts exclusive to user 48 (e.g., exclusive to the first instant messaging contacts list) or exclusive to user 50 (e.g., exclusive to the second instant messaging contacts list), respectively, with user 46, e.g., by adding the common contacts to user 46's instant messaging contacts list (e.g., contacts list 152).

The one or more instant messaging contacts included within the one or more comparison instant messaging contacts may be associated 118 with one of the first instant messaging contacts list and the second instant messaging contacts list. For example, as described above with reference to FIG. 3, right-clicking, on one or more of the instant messaging contacts (e.g., user 48) from instant messaging contacts list 152, may result in contacts intersection process 10 (alone or in conjunction with one or more of instant messaging server application 20 and/or instant messaging client application 22) render pop-up menu 156, which may include the options “Compare Buddies” and “Compare to Me”. Selecting “Compare to Me” from pop-up menu 156 may result in contacts intersection process 10 designating an instant messaging contacts list associated with user 46 as a first instant messaging contacts list and designating an instant messaging contacts list associated with user 48 as a second instant messaging contacts list.

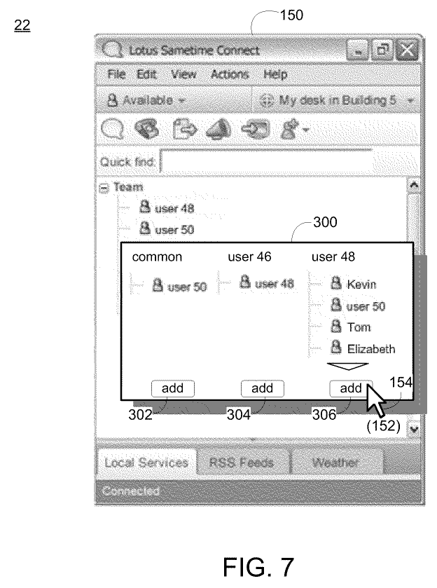

As described above, contacts intersection process 10 may identify 100 one or more instant messaging contacts associated with a first instant messaging contacts list (e.g., an instant messaging contacts list associated with user 46), and may identify 102 one or more instant messaging contacts associated with a second instant messaging contacts list (e.g., an instant messaging contacts list associated with user 48). Contacts intersection process 10 may further compare 104 the one or more instant messaging contacts associated with user 46 to the one or more instant messaging contacts associated with user 48. Referring also to FIG. 7, contacts intersection process 10 (alone or in conjunction with instant messaging client application 22 and/or instant messaging server application 20) may render comparison pop-up 300, e.g., relative to instant messaging contacts display 150. The one or more comparison instant messaging contacts may be based upon, at least in part, one or more instant messaging contacts associated with both of the first instant messaging contacts list (e.g., the instant messaging contacts list associated with user 46) and the second instant messaging contacts list (e.g., the instant messaging contacts list associated with user 48). For example, as shown in comparison pop-up 300, contacts intersection process 10 may indicate one or more instant messaging contacts common to both list 150 and 250 (e.g., user 50 under the column heading “common”), as well as one or more instant messaging contacts exclusive to user 46 and exclusive to user 48, respectively. User 46 may select “add” button 306, resulting in contacts intersection process 10 associating 118 the comparison contacts listed under “user 48” with the first instant messaging contacts list (e.g., the instant messaging contacts list associated with user 46).

In addition to determining 106 one or more comparison contacts based upon, at least in part, a first instant messaging contacts list associated with a first instant messaging user and a second instant messaging contacts list associated with a second instant messaging user, contacts intersection process 10 may determine 106 one or more comparison contacts based upon a first instant messaging contacts list and a second instant messaging contacts list associated with a single instant messaging user. For example, as shown in FIG. 4, user 48's instant messaging contacts may be divided into groups (namely “Team” and “Personal”). In a similar manner as described above with reference to FIG. 3, right-clicking, on each of “Team” and “Personal” from listing 202, may result in contacts intersection process 10 (alone or in conjunction with one or more of instant messaging server application 20 and/or instant messaging client application 24) render a pop-up menu, which may include the options “Compare Buddies” and “Compare to Me”. Selecting “Compare Buddies” from the pop-up menu may result in contacts intersection process 10 designating the group “Team” as a first instant messaging contacts list and designating the group “Personal” as a second instant messaging contacts list.

As described above, contacts intersection process 10 may identify 100 one or more instant messaging contacts associated with a first instant messaging contacts list (e.g., the group “Team”), and may identify 102 one or more instant messaging contacts associated with a second instant messaging contact list (e.g., the group “Personal”). Contacts intersection process 10 may further compare 104 the one or more instant messaging contacts from the group “Team” to the one or more instant messaging contacts from the group “Personal”. While not shown, contacts intersection process 10 (alone or in conjunction with instant messaging client application 24 and/or instant messaging server application 20) may render a comparison pop-up that may display those instant messaging contacts common to both group “Team” and group “Personal”, as well as those instant messaging contacts exclusive to each of group “Team” and group “Personal”. Accordingly, it may be possible for user 48 to discern what, if any, overlap exists between two or more different groups within user 48's instant messaging contacts.

While not shown, contacts intersection process 10 may allow a user (e.g., user 46) to filter the one or more comparison instant messaging contacts. For example, as shown in FIGS. 6 and 7, determining 106 the one or more comparison instant messaging contacts may include identifying contacts that are common to the first instant messaging contacts list and the second instant messaging contacts list, as well as those contacts that are exclusive to each of the first instant messaging contacts list and the second instant messaging contacts list. Contacts intersection process 10 may further allow user 46 to filter the one or more determined 106 comparison instant messaging contacts, e.g., to remove one or more of the comparison instant messaging contacts and/or to modify an order in which the one or more comparison contacts are displayed (e.g., in comparison pop-up 300). The one or more comparison instant messaging contacts may be filtered based on various criteria and/or attributed that may vary according to design criteria and/or user need. Examples of filtering criteria and/or attributes may include, but are not limited to, preferences, organizational level of the one or more comparison instant messaging contacts, department, etc.

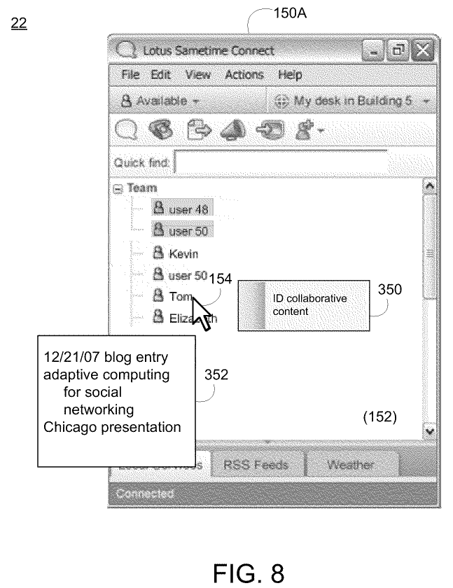

Collaborative content associated with one or more of the comparison instant messaging contacts may be identified 120. Collaborative content may include, for example, documents, weblog entries, metadata tags, etc., created by one or more of the comparison contacts. For example, and referring also to FIG. 8, user 46 may select, via onscreen pointer 154, an instant messaging contact (e.g., Tom) from updated contacts list 150A (e.g., which may include user 46's original instant messaging contacts and comparison contacts associated 116, 118 with user 46 by contacts intersection process 10). Selecting “Tom”, may result in contacts intersection process 10 (alone or in conjunction with one or more of instant messaging client application 22 and instant messaging server application 20) rendering pop-up 350. While pop-up 350 is shown including only a single option (namely “ID collaborative content), this is for illustrative purposes only, as the number and nature of options included within pop-up 350 may vary according to user need and design criteria.

Selecting, via onscreen pointer 154, “ID collaborative content” from within pop-up 350 may result in contacts intersection process 10 (alone or in conjunction with one or more of instant messaging client application 22 and/or instant messaging server application 20) rendering listing 352. Listing 352 may include a listing of collaborative content created by and/or edited by “Tom”, namely “Dec. 21, 2007 blog entry”, “adaptive computing for social networking”, and “Chicago presentation.” User 46 may select, via onscreen pointer 154 one or more of the items of collaborative content, e.g., allow the selected item of collaborative content to be retrieved by a suitable application (e.g., a web browser, word processor, etc.).

While various embodiments and implementations have been shown and described, it should be understood that the foregoing description is intended for illustrative purposes only, as numerous variations and modifications are possible. As such, the invention should be afforded the full scope of the claims appended hereto.

What is claimed is:

1. A method comprising:
identifying one or more instant messaging contacts associated with a first instant messaging contacts list;
identifying one or more instant messaging contacts associated with a second instant messaging contacts list;
comparing the one or more instant messaging contacts associated with the first instant messaging contacts list to the one or more instant messaging contacts associated with the second instant messaging contacts list; and
determining one or more comparison instant messaging contacts.

2. The method of claim 1, wherein identifying one or more instant messaging contacts associated with the first instant messaging contacts list includes requesting one or more instant messaging contacts associated with the first instant messaging contacts list.

3. The method of claim 1, wherein identifying one or more instant messaging contacts associated with the first instant messaging contacts list includes receiving one or more instant messaging contacts associated with the first instant messaging contacts list based upon, at least in part, permissions defined relative to at least a portion of the one or more instant messaging contacts associated with the first instant messaging contacts list.

4. The method of claim 1, wherein identifying one or more instant messaging contacts associated with the first instant messaging contacts list includes querying a first instant messaging client.

5. The method of claim 1, wherein identifying one or more instant messaging contacts associated with the first instant messaging contacts list includes querying a first instant messaging server associated with the first instant messaging contacts list.

6. The method of claim 1, wherein the one or more comparison instant messaging contacts are based upon, at least in part, one or more instant messaging contacts associated with both of the first instant messaging contacts list and the second instant messaging contacts list.

7. The method of claim 6, further including associating one or more comparison instant messaging contacts with a third instant messaging contacts list.

8. The method of claim 1, wherein the one or more comparison instant messaging contacts are based upon, at least in part, one or more instant messaging contacts exclusive to one of the first instant messaging contacts list or the second instant messaging contacts list.

9. The method of claim 8, further including associating the one or more instant messaging contacts included within the one or more comparison instant messaging contacts with one of the first instant messaging contacts list and the second instant messaging contacts list.

10. The method of claim 1, further including identifying collaborative content associated with one or more of the comparison instant messaging contacts.

11. A computer program product comprising a computer readable medium having a plurality of instructions stored thereon, which, when executed by a processor, cause the processor to perform operations comprising:
identifying one or more instant messaging contacts associated with a first instant messaging contacts list;
identifying one or more instant messaging contacts associated with a second instant messaging contacts list;
comparing the one or more instant messaging contacts associated with the first instant messaging contacts list to the one or more instant messaging contacts associated with the second instant messaging contacts list; and
determining one or more comparison instant messaging contacts.

12. The computer program product of claim 11, wherein the instructions for identifying one or more instant messaging contacts associated with the first instant messaging contacts list include instructions for requesting one or more instant messaging contacts associated with the first instant messaging contacts list.

13. The computer program product of claim 11, wherein the instructions for identifying one or more instant messaging contacts associated with the first instant messaging contacts list include instructions for receiving one or more instant messaging contacts associated with the first instant messaging contacts list based upon, at least in part, permissions defined relative to at least a portion of the one or more instant messaging contacts associated with the first instant messaging contacts list.

14. The computer program product of claim 11, wherein the instructions for identifying one or more instant messaging contacts associated with the first instant messaging contacts list include instructions for querying a first instant messaging client.

15. The computer program product of claim 11, wherein the instructions for identifying one or more instant messaging contacts associated with the first instant messaging contacts list include instructions for querying a first instant messaging server associated with the first instant messaging contacts list.

16. The computer program product of claim 11, wherein the one or more comparison instant messaging contacts are based upon, at least in part, one or more instant messaging contacts associated with both of the first instant messaging contacts list and the second instant messaging contacts list.

17. The computer program product of claim 16, further including instructions for associating one or more comparison instant messaging contacts with a third instant messaging contacts list.

18. The computer program product of claim 11, wherein the one or more comparison instant messaging contacts are based upon, at least in part, one or more instant messaging contacts exclusive to one of the first instant messaging contacts list or the second instant messaging contacts list.

19. The computer program product of claim 18, further including instructions for associating the one or more instant messaging contacts included within the one or more comparison instant messaging contacts with one of the first instant messaging contacts list and the second instant messaging contacts list.

20. The computer program product of claim 11, further including instructions for identifying collaborative content associated with one or more of the one or more comparison instant messaging contacts.
